(19) United States
(12) Patent Application Publication
(10) Pub. No.: US 2023/0413889 A1
(43) Pub. Date: Dec. 28, 2023

(54) EXTRUDED PARTICLE

(71) Applicant: Firmenich SA, Satigny (CH)

(72) Inventors: Pierre-Etienne BOUQUERAND, Satigny (CH); Fei ZHANG, Satigny (CH)

(21) Appl. No.: 18/251,706

(22) PCT Filed: Nov. 8, 2021
(86) PCT No.: PCT/EP2021/080969

§ 371 Date: May 3, 2023

(30) Foreign Application Priority Data
Nov. 10, 2020 (EP) 20206605.6

(51) Int. Cl. A23P 10/25; A23P 10/35; A23L 27/00; A23L 29/30; A23L 29/212

(52) U.S. Cl. CPC A23P 10/25; A23P 10/35; A23L 27/72; A23L 29/35; A23L 29/212

(57) ABSTRACT

The present invention relates to the field of delivery systems. More particularly, the present invention relates to extruded particles, preferably flavored extruded particles, comprising a solid fat coating. The present invention also relates to a process for preparing said extruded particles.

### TECHNICAL FIELD

The present invention relates to the field of delivery systems. More particularly, the present invention relates to extruded particles, preferably flavored extruded particles comprising a solid fat coating (i.e hydrophobic coating). The present invention also relates to a process for preparing said extruded particles as well as consumer products comprising said extruded particles.

### BACKGROUND OF THE INVENTION

The consumer's demand for delivery systems is more and more important and is driving the development of new delivery systems.

Delivery systems in form of particles are commonly used in the field of flavoring or perfuming because they are easy to dose, handle and prepare.

Depending on the applications, the delivery system can be subjected to high moisture environment that can lead to instability of said delivery system upon storage.

Among flavor delivery systems, few can be considered as waterproof or not moisture sensitive. One may cite for example coacervate core-shell microcapsules which release flavor upon mechanical breakage. However, this system is limited by the range of actives that can be encapsulated according to their polarity.

In the great majority of solid delivery systems like spray-drying and extrusion, the flavoring molecules are entrapped into an amorphous glassy matrix of a carrier, typically starch hydrolysates. The release mechanism is mainly based on the dissolution making those systems sensitive to moisture. The usual solution to improve moisture stability of such delivery systems is to increase the carrier system molecular weight but there are some limitations in terms of viscosity and barrier properties. Another way to improve moisture stability of solid delivery system is to coat them with a hydrophobic layer. This coating is usually achieved by spraying a molten solid fat using fluidized bed or tumbler and requires therefore an additional process step.

It would be therefore desirable to provide an extruded particle having an enhanced moisture stability and that would be prepared by a simple process.

The present invention provides a solution to the above-mentioned problems.

### DETAILED DESCRIPTION

It has been surprisingly found that a particle having a hydrophobic coating (made of a solid fat) could be obtained by extrusion without requiring an additional step. Indeed, when a solid fat is added to a regular formulation (i.e mixture of carrier material and active ingredient such as a flavor oil), said fat is subjected to a phase separation upon temperature during the process and will set at the surface of the particle when the molten mass is commuted in smaller entities during the cutting step, forming therefore a hydrophobic coating.

Therefore, a first object of the invention is a process for preparing an extruded particle, wherein it comprises the following steps:
a) mixing at least a carrier material and a plasticizer, preferably water, to form a mixture;
b) heating the mixture at a temperature sufficient to form a molten mass;
c) extruding the molten mass through a die to form an extrudate;
d) cutting the extrudate to form an extruded particle,
   wherein a solid fat having a melting point Tm and an active ingredient, preferably comprising a flavor or a perfume, are added to the mixture in step a) and/or in the molten mass in step b), and
   wherein at least step c) and step d) are carried out at a temperature greater than Tm.

Unless stated otherwise, percentages (%) are meant to designate a percentage by weight of a composition.

By «at least step c) and step d) are carried out at a temperature greater than Tm“, it should be understood that the molten mass in step c) and the extrudate in step d) has a temperature greater than Tm.

In a particular embodiment, the particle is an amorphous particle.

In a particular embodiment, the particle has a glass transition temperature of equal to or greater than 25° C., preferably equal to or greater than 30° C. and more preferably equal to or greater than 40° C. In a particular embodiment, the particle, preferably flavor particle has a glass transition temperature of equal to or less than 120° C., preferably equal to or less than 100° C. and more preferably equal to or less than 90° C. In a particular embodiment, the flavor particle has a glass transition temperature greater than 25° C. and less than 120° C., preferably greater than 35° C. and less than 100° C. and more preferably 40° C. to 90° C. The glass transition temperature can be measured by standard methods known by a skilled person such as by using a differential scanning calorimeter DSC822e (Mettler).

In a particular embodiment, the particle is in a solid, granular state.

In a particular embodiment, the particle is free-flowing.

In a particular embodiment, the particle has an average particle size of equal to or greater than 300 μm and preferably equal to or greater than 500 μm. In a particular embodiment, the flavor particle has an average particle size of equal to or less than 1 cm, preferably equal to or less than 5 mm and more preferably equal to or less than 3 mm. In a particular embodiment, the particle, preferably flavor particle has an average particle size of 300 to 10 000 μm, preferably 500 to 3000 μm. The average particle size can be measured by standard methods known by a skilled person such as by using Beckman Coulter Laser Diffraction Particle Size Analyzer (Coulter LS 13320) with Tornado Dry Powder Module (Beckman Coulter Inc., Miami, FL). The average particle size can be also determined by sieving.

The carrier material of step a) can be any compound which can be readily processed through extrusion techniques to form a dry extruded solid.

In a particular embodiment, the carrier material of step a) is practically neutral from a flavor point of view, i.e. that does not significantly alter the organoleptic properties of flavoring ingredients.

In a particular embodiment, the carrier material of step a) is a solid carrier.

In a particular embodiment, the carrier material of step a) is a biopolymer.

Biopolymers can be defined as chain-like molecules made up of repeating chemical blocks produced from renewable resources which could be degraded in the environment.

In a particular embodiment, the carrier material of step a) is a food grade biopolymer.

In a particular embodiment, the carrier material of step a) is a water-soluble food grade biopolymer. Water-soluble food grade biopolymer typically includes macromolecules (including proteins, nucleic acids and polysaccharides) formed by living organisms.

In a particular embodiment, the carrier material of step a) is a starch derivative, gums, fibers, polysaccharides, proteins, soluble flours or mixtures thereof.

The term “starch derivative” has the normal meaning of the term to a person skilled in the art. Starch derivatives are prepared by enzymatically, physically or chemically treating native starch to alter its properties.

The term “hydrolyzed starch” means an oligosaccharide-type material typically obtained by acid and/or enzymatic hydrolysis of starch, preferably corn starch.

According to a particular embodiment, the hydrolyzed starch is chosen in the group consisting of maltodextrins, dextrins, corn syrup and mixture thereof.

According to a particular embodiment, the carrier material comprises also a modified starch.

The term “modified starch” has the normal meaning of the term to a person skilled in the art, i.e a starch that has been physically modified (physical modification), enzymatically modified (enzymatic modification) or chemically modified (chemical modification).

“Physically modified starch” means a starch which has been subjected to a heat treatment in the presence of relatively small amounts of water or moisture. No other reagents are added to the starch during the heat treatment. The heat-treatment processes include heat-moisture and annealing treatments, both of which cause a physical modification of starch without any gelatinization.

“Enzymatically modified starch” means a starch which has been treated with one or more enzymes to modify its properties.

“Chemically modified starch” means a starch which has been reacted with reagents which have been added to the starch in order to form new covalent bonds between those molecules and the starch molecules.

Particular examples of modified starches comprise hydroxypropylated starch, phosphate starch phosphate, octenylsuccinated starch, starch aluminium octenyl succinate, acetylated distarch phosphate, acetylated distarch adipate, acetylated distarch adipate, hydroxypropyl distarch phosphate and acetylated oxidized starch. Some non-limited examples include octenylsuccinic anhydride-modified starches such as MiraCape by Tate & Lyle, Capsule by Ingredion, EmCape by Cargill, etc.

Particular examples of starch derivatives comprise maltodextrin, dextrin, resistant starch, hydroxypropylated starch, phosphate starch phosphate, octenylsuccinated starch, starch aluminium octenyl succinate, acetylated distarch phosphate, acetylated distarch adipate, acetylated distarch adipate, hydroxypropyl distarch phosphate and acetylated oxidized starch.

The term “gums” has the normal meaning of the term to a person skilled in the art. Gums can be derived from botanical sources, seaweeds, and bacteria fermentation. Particular examples of gums comprise gum arabic, gum tragacanth, gum karaya, gum ghatti, ocra gum, glucomannan, gellan gum, alginate, etc. The term “fibers” has the normal meaning of the term to a person skilled in the art. They cannot be digested by human body's enzymes. Particular examples of fibers comprise inulin, fructooligosaccharides, beta glucan, arabinogalactan, glucomannan, psyllium, soluble corn fiber etc. The term “polysaccharides” has the normal meaning of the term to a person skilled in the art. Particular examples of polysaccharides comprise tamarind seed polysaccharide, soy polysaccharide, galactomannan, xyloglucan, carrageenan, pectin, curdlan, arabinan, arabinoglactan, etc. The term “proteins” has the normal meaning of the term to a person skilled in the art. Particular examples of proteins comprise pea protein, soy protein, lentil proteins, chickpea protein, rice protein, potato protein, fava bean protein, mung bean protein, canola protein, etc. The term “soluble flour” has the normal meaning of the term to a person skilled in the art. Soluble fours are flours with chemical, physical, or enzymatical treatment to increase their solubility and functionality. Particular examples of soluble flours comprise soluble rice flour, soluble brown rice flour, koji rice, etc.

In a particular embodiment, the carrier material comprises a maltodextrin with a dextrose equivalent (DE) of about 1 to about 20.

In a particular embodiment, the maltodextrin is selected from a maltodextrin with a DE of about 10 up to about 18 DE.

In another embodiment, the carrier material comprises corn syrup with a DE from 21 up to 49. Any carrier material can be used that is made by the hydrolysis of starches from different origins such as, but not limited to, maize, wheat, potato or rice. In another embodiment, the carrier material is a hydrogenated starch hydrolysate (e.g., HSPolyols), fructose oligosacharides (e.g., but not limited to Inulin from Orafit), soluble fibers such as for example but not limited to Nutriose (Roquette) and pregelatinized starch.

The glass transition temperature of the active material (for example flavour) and carrier mixture depends on the amount of plasticizer added to the initial mixture.

According to an embodiment, the glass transition temperature of the particle is substantially the same as the glass transition temperature of the mixture. This is attained by ensuring low or no loss of water.

According to this particular embodiment, a small amount of plasticizer, preferably water, is added to the mixture to guarantee that the glass transition temperature (T g) of the resulting melt corresponds to and is substantially the same as that of the desired T g value of the final product.

In other words, contrary to other methods such as wet-granulation, the glass transition temperature of the mixture before extrusion has already the value required for the final product, which temperature is above room temperature and preferably above 40° C. so that the product can be stored at ambient temperature in the form of free-flowing particles. Consequently, this embodiment of the invention can dispense with the additional drying step following the extrusion, intended to remove water in order to increase T g to an acceptable value, and therefore reduce the energy needs.

The proportions in which plasticizer is employed in the present invention therefore vary in a wide range of values which the skilled person is capable of adapting and choosing as a function of the nature of the carrier and the required T g of the final product.

According to an embodiment, the plasticizer content is such that said mixture has a glass transition temperature T g above room temperature.

The plasticizer is preferably water, however polyols such as glycerol, propylene glycol and there esters (i.e.Triacetine) could be used as well. Small polar molecules can be used to lower the Tg, one may cite also organic acids (citric, maleic . . . ), amino acids, mono and disaccharides (glucose, maltose fructose, sucrose . . . ) and mixtures thereof.

Typically, the plasticizer is used in an amount comprised between 0.5 and 10%, preferably between 5 and 9%, based on the total weight of the mixture of step a).

In a particular embodiment, a lubricant is provided in step a) and/or in step b). While not wishing to be bound to any theory it is believed that the lubricant reduces shear and expansion of the molten mass at the exit die. In some embodiments, the lubricant may comprise a medium chain triglyceride (MCT). In another embodiment, the lubricant comprises a micellar surfactant like lecithin or a fatty acid ester (e.g., citric, tartaric, acetic), DATEM, CITREM or mixtures of the above. In a particular embodiment, the lubricant may be provided in an amount, by weight, up to about 5%, particularly about 0.2 up to about 5%, more particularly from about 0.8% up to about 2% and even more particularly from about 1 to 2% of the total weight of the mixture of step a).

According to a particular embodiment, a low molecular weight carbohydrate is added in step a), preferably chosen in the group consisting of sucrose, glucose, lactose, maltose, fructose, ribose, dextrose, isomalt, sorbitol, mannitol, xylitol, lactitol, maltitol, pentatol, arabinose, glucose syrup, pentose, xylose, galactose, Trehalose®, and preferably provided in an amount, by weight between 1 and 10%, preferably 2 and 6% based on the total weight of the mixture of step a).

According to an embodiment, an additional component preferably chosen in the group consisting of gums, proteins, small molecule surfactant, plant extract, saponins, plant-derived proteins, protein hydrolysates, citrus fiber, sugar beet fiber or mixtures thereof is added in step a) and/or b), preferably in an amount comprised between 1 to 30 wt. %, preferably 5 to 20 wt. % and more preferably 10 to 20 wt. % (based on the total weight of the particle, preferably flavor particle).

The term “gums” has the normal meaning of the term to a person skilled in the art. Particular examples of gums comprise gum arabic, gum karaya, gum ghatti, gum tragacanth, okra gum, etc. The term “proteins” has the normal meaning of the term to a person skilled in the art. Particular examples of proteins comprise pea protein, soy protein, lentil proteins, chickpea protein, rice protein, potato protein, fava bean protein, mung bean protein, canola protein, etc. The term “small molecule surfactant” has the normal meaning of the term to a person skilled in the art. Particular examples of small molecule surfactants comprise quillaja saponins, yucca saponins, phospholipids, lecithin, lysolecithin, diacetyltartaric and fatty acid esters of glycerol (DATEM), citric acid esters of mono and diglycerides (CITREM), etc.

The mixture of step a) is then heated within an extruder, typically a single screw-extruder, a twin-screw extruder or a ram extruder, preferably a twin-screw extruder.

According to a particular embodiment, step a) is carried out at a temperature greater than Tm.

According to a particular embodiment, step b) is carried out at a temperature greater than Tm.

The mixture of step a) is thus extruded in the extruder, which maintains the temperature of the mixture at a predetermined temperature which is comprised preferably between 90 and 130° C. This temperature is adapted to the system of the invention. Indeed, it has to be above the glass transition temperature of the carrier material and also above Tm (melting temperature) of the solid fat in order to keep the mixture in the form of a molten mass. Pressure is also applied and adjusted to a value appropriate to maintain homogeneity of the melt. Typically, pressure values of up to 100 bar (10⁷ Pa) can be used depending on the size of the equipment.

According to the invention, an active ingredient (e.g a flavor oil or a perfume oil) and a solid fat having a melting temperature (typically above RT) are added to the mixture in step a) and/or in the molten mass in step b).

According to the invention, the cutting step occurs when fat is in its liquid state.

According to an embodiment, the active ingredient is a hydrophilic material. According to an embodiment, the active ingredient is a hydrophobic material.

According to a preferred embodiment, the active ingredient comprises a flavor or a perfume, According to a preferred embodiment, the active ingredient is a flavor or a perfume.

According to a preferred embodiment, the active ingredient is a flavor oil or a perfume oil.

According to an embodiment, the hydrophobic material is a hydrophobic active ingredient.

According to an embodiment, the active ingredient is added in an amount comprised between 1 and 20% based on the weight of the mixture obtained after step a) or step b).

According to a preferred embodiment, the active ingredient comprises a flavour oil or a perfume oil. Alternative ingredients which could benefit from being encapsulated could be used either instead of a perfume or flavour, or in combination with a perfume or flavour. Non-limiting examples of such ingredients include a cosmetic, skin caring, malodour counteracting, bactericide, fungicide, pharmaceutical or agrochemical ingredient, a sanitizing agent, an insect repellent or attractant, and mixture thereof.

The nature and type of the insect repellent or attractant that can be present in the hydrophobic internal phase do not warrant a more detailed description here, which in any case would not be exhaustive, the skilled person being able to select them on the basis of its general knowledge and according to the intended use or application.

Examples of such insect repellent or attractant are birch, DEET (N,N-diethyl-m-toluamide), essential oil of the lemon eucalyptus (Corymbia citriodora) and its active compound p-menthane-3,8-diol(PMD), icaridin (hydroxyethyl isobutyl piperidine carboxylate), Nepelactone, Citronella oil, Neem oil, Bog Myrtle (Myrica Gale), Dimethyl carbate, Tricyclodecenyl allyl ether, IR3535 (3-[N-Butyl-N-acetyl]-aminopropionic acid, ethyl ester, Ethylhexanediol, Dimethyl phthalate, Metofluthrin, Indalone, SS220, anthranilate-based insect repellents, and mixtures thereof.

By “flavor oil”, it is meant here a flavoring ingredient or a mixture of flavoring ingredients, solvents or adjuvants of current use for the preparation of a flavoring formulation, i.e. a particular mixture of ingredients which is intended to be added to an edible composition or chewable product to impart, improve or modify its organoleptic properties, in particular its flavor and/or taste. Flavoring ingredients are well known to a person skilled in the art and their nature does not warrant a detailed description here, which in any case would not be exhaustive, the skilled flavorist being able to select them on the basis of his general knowledge and according to the intended use or application and the organoleptic effect it is desired to achieve. Many of these flavoring ingredients are listed in reference texts such as in the book by S. Arctander, Perfume and Flavor Chemicals, 1969, Montclair, N.J., USA, or its more recent versions, or in other works of similar nature such as Fenaroli's Handbook of Flavor Ingredients, 1975, CRC Press or Synthetic Food Adjuncts, 1947, by M. B. Jacobs, van Nostrand Co., Inc. Solvents and adjuvants of current use for the preparation of a flavoring formulation are also well known in the art.

In a particular embodiment, the flavor is a mint flavor. In a more particular embodiment, the mint is selected from the group consisting of peppermint and spearmint.

In a further embodiment, the flavor is a cooling agent or mixtures thereof.

In another embodiment, the flavor is a menthol flavor.

Flavors that are derived from or based on fruits where citric acid is the predominant, naturally-occurring acid include but are not limited to, for example, citrus fruits (e.g. lemon, lime), limonene, strawberry, orange, and pineapple. In one embodiment, the flavors food is lemon, lime or orange juice extracted directly from the fruit. Further embodiments of the flavor comprise the juice or liquid extracted from oranges, lemons, grapefruits, key limes, citrons, clementines, mandarins, tangerines, and any other citrus fruit, or variation or hybrid thereof. In a particular embodiment, the flavor comprises a liquid extracted or distilled from oranges, lemons, grapefruits, key limes, citrons, clementines, mandarins, tangerines, any other citrus fruit or variation or hybrid thereof, pomegranates, kiwifruits, watermelons, apples, bananas, blueberries, melons, ginger, bell peppers, cucumbers, passion fruits, mangos, pears, tomatoes, and strawberries.

In a particular embodiment, the flavor comprises a composition that comprises limonene, in a particular embodiment, the composition is a citrus that further comprises limonene.

In another particular embodiment, the flavor comprises a flavor selected from the group comprising strawberry, orange, lime, tropical, berry mix, and pineapple.

The phrase flavor includes not only flavors that impart or modify the smell of foods but include taste imparting or modifying ingredients. The latter do not necessarily have a taste or smell themselves but are capable of modifying the taste that other ingredients provides, for instance, salt enhancing ingredients, sweetness enhancing ingredients, umami enhancing ingredients, bitterness blocking ingredients and so on.

In a further embodiment, suitable sweetening components may be included in the particles described herein. In a particular embodiment, a sweetening component is selected from the group consisting of sugar (e.g., but not limited to sucrose), a stevia component (such as but not limited to stevioside or rebaudioside A), sodium cyclamate, aspartame, sucralose, sodium saccharine, and Acesulfam K or mixtures thereof.

By “perfume oil” (or also “perfume”) or “flavour” what is meant here is an ingredient or composition that is a liquid at about 20° C. Said perfume or flavour oil can be a perfuming or flavouring ingredient alone or a mixture of ingredients in the form of a perfuming or flavouring composition. As a “perfuming ingredient” it is meant here a compound, which is used in perfuming preparations or compositions to impart as primary purpose a hedonic effect. In other words such an ingredient, to be considered as being a perfuming one, must be recognized by a person skilled in the art as being able to at least impart or modify in a positive or pleasant way the odor of a composition, and not just as having an odor. The nature and type of the perfuming ingredients present in the oil phase do not warrant a more detailed description here, which in any case would not be exhaustive, the skilled person being able to select them on the basis of its general knowledge and according to intended use or application and the desired organoleptic effect. In general terms, these perfuming ingredients belong to chemical classes as varied as alcohols, aldehydes, ketones, esters, ethers, acetates, nitriles, terpenoids, nitrogenous or sulphurous heterocyclic compounds and essential oils, and said perfuming co-ingredients can be of natural or synthetic origin. Many of these co-ingredients are listed in reference texts such as the book by S. Arctander, Perfume and Flavor Chemicals, 1969, Montclair, New Jersey, USA, or its more recent versions, or in other works of a similar nature, as well as in the abundant patent literature in the field of perfumery. It is also understood that said ingredients may also be compounds known to release in a controlled manner various types of perfuming compounds.

For an active ingredient in a solid form, the addition in step a) is more appropriate whereas for an active ingredient (e.g a flavor oil) in a liquid form, the addition in step b) is more appropriate.

According to a particular embodiment, the active ingredient (e.g a flavor oil) is added in step a).

According to a particular embodiment, the active ingredient (e.g a flavor oil) is added in step b).

The term “fat” used in the present invention refers to lipid components that are solid or in the form of a paste at room temperature (typically between 20° C. and 30° C., more particularly at whereas the term “oil” used in the present invention refers to lipid components that are liquid at room temperature. It should be understood that depending on the temperature during the different steps of the process, the fat can be in a solid state or in a liquid state.

The person skilled in the art would be able to select a suitable solid fat according to its melting point. According to the invention, the solid fat has a melting point (Tm) above the room temperature.

The melting point (Tm) of a material can be easily determined by the person skilled in the art or found in the literature. The melting point can be measured by differential scanning calorimeter (DSC). A typical method is the following: measurements are conducted on a Mettler-Toledo DSC822e with a 40 μL aluminium crucible. The samples are held at −10° C. for 2 min and the temperature is ramped up to 150° C. at 10° C./min. Melting signature is a clear endothermic peak which apex represents the melting point temperature.

Among the suitable fat that can be used in the present invention, as non-limiting example, one may cite beeswax, candelilla wax, carnauba wax, paraffin wax, palm fat, shea butter, algae butter, hydrogenated vegetable oil, palm stearin, shea stearin, rice stearin, sunflower stearin, tallow, cocoa butter, saturated fatty acid (such as Lauric acid, myristic acid, palmitic acid, stearic acid, Arachidic acid and their corresponding mono, di and triglycerides having a melting point above room temperature), and mixtures thereof.

According to an embodiment, the melting temperature of the fat is ranged from 30 to 90° C. According to an embodiment, the melting temperature of the fat is ranged from 40 to 90° C. According to another embodiment, the melting temperature of the fat is ranged from 50 to 90° C.

The particle surface to be covered by the fat is related at the squared value of the particles size. Consequently, the person skilled in the art will be able to adapt the amount of solid fat to the desired particle size.

According to an embodiment, the amount of the solid fat is comprised between 0.5 and 30% ww, preferably between 1 and 10% by weight based on the carrier system composed of the carrier material and the solid fat.

According to an embodiment, as the mixture comes to the die part of the extruder, the temperature is still above the glass transition temperature of the carrier and also above Tm of the solid fat. The extruder is equipped with a die face cutter and the mixture is thus cut at the temperature of the melt. Once cooled to ambient temperature, the already cut glassy material does not need to be shaped or dried in a spheroniser, fluid-bed dryer or other device, unlike what is the case with other processes where the molten carrier is cooled prior to the cutting. In a particular embodiment the surrounding air comprises chilled air.

According to an embodiment, the process comprises an additional step between step b) and step c) consisting of pumping the molten mass and pushing said molten mass through a static mixer. The pumping step can be carried out by using a gear pump, preferably a polymer gear pump, which allows to take the melt coming out of the extruder and pushing it through the static mixer or can be also done only thanks to the effect of the twin-screw extruder itself.

During the extrusion process, the mixture is forced through a die having an orifice with a predetermined diameter which ranges typically from about 0.250 to 10 mm, more particularly from about 0.5 up to about 3.0 mm and more particularly from 0.7 to 3.0 mm. However, much larger diameters for the die are also possible.

In a particular embodiment, the powder may be extruded at a throughput of 10-25 kg/h through a 0.7 mm die hole using for example, but not limited to a Thermo Prism 16 mm twin-screw lab extruder or a Clextral BC21 equipped with a cutter knife in order to granulate the melt at the die exit.

In general, the extruder barrel consists of multiple barrel sections, which are independently temperature controlled. In one embodiment, the extruder comprises 2 to 9 heating and cooling zones with temperatures ranging from 20 to about 120° C.

Another object of the present invention is an extruded particle obtainable by the process as defined above.

According to an embodiment, the extruded particle comprises:
an active ingredient, preferably comprising a flavor or a perfume dispersed in a matrix made of a carrier material, and
a coating comprising a solid fat.

It should be understood that the particles of the invention comprise a hydrophobic coating (i.e made of a solid fat).

According to a particular embodiment, the particle size is greater than 300 microns, preferably greater than 500 microns.

It has been shown that the presence of the hydrophobic coating provides an enhanced moisture stability. Indeed, according to an embodiment, the extruded particle has an enhanced moisture stability as the particle keep its integrity at 80% relative humidity and 25° C. No visual collapse or melting have been observed in those conditions.

The particles of the invention can be used in a great variety of edible end products.

Another object of the invention is therefore a flavored consumer product or perfumed consumer product comprising the extruded particles as defined above.

By “consumer product” or “end-product” it is meant a manufactured product ready to be distributed, sold and used by a consumer.

Flavored Consumer Products

End products are more particularly a food, pet-food or feed products.

As the particles of the invention comprise a hydrophobic coating they are particularly advantageous for dry food product susceptible to rehydrated like instant drinks (PSD, chocolate, coffee), confectionary like chewing gum, instant noodles or stock cubes.

The particles of the invention are particularly advantageous to food product with a relatively high-water activity such as ready to use meal, meat analogs, microwave food, pasta boxes.

The particles of the invention can be used in vegetarian meat analogues or meat replacers, vegetarian burger, sausages, patties, chicken-imitate nuggets . . . , meat products (e.g. processed meat, poultry, beef, pork, ham, fresh sausage or raw meat preparations, spiced or marinated fresh meat or cured meat products, reformed meat) or extended meat products making use of a combination of animal and vegetable protein in varying ratios, often being coextruded or a mix between textured vegetable protein and animal protein.

Meat, for the purpose of the present invention, encompasses red meat, such as beef, pork, sheep, lamb, game and poultry, such as chicken, turkey, goose and duck. Preferably, the food of the present invention is meat selected from beef, poultry and pork.

Nevertheless, the particles of the invention can also be of particular interest in the following examples of products:
Baked goods (e.g. bread, dry biscuits, cakes, other baked goods),
Non-alcoholic beverages (e.g. carbonated soft drinks, bottled waters, sports/energy drinks, juice drinks, vegetable juices, vegetable juice preparations),
Alcoholic beverages (e.g. beer and malt beverages, spirituous beverages),
Instant beverages (e.g. instant vegetable drinks, powdered soft drinks, instant coffee and tea),
Cereal products (e.g. breakfast cereals, pre-cooked ready-made rice products, rice flour products, millet and sorghum products, raw or pre-cooked noodles and pasta products),
Milk products (e.g. fresh cheese, soft cheese, hard cheese, milk drinks, whey, butter, partially or wholly hydrolysed milk protein-containing products, fermented milk products, condensed milk and analogues),
Dairy based products (e.g. fruit or flavored yoghurt, ice cream, fruit ices)
Confectionary products (e.g. chewing gum, hard and soft candy)
Chocolate and compound coatings
Products based on fat and oil or emulsions thereof (e.g. mayonnaise, spreads, margarines, shortenings, remoulade, dressings, spice preparations),
Spiced, marinated or processed fish products (e.g. fish sausage, surimi),
Eggs or egg products (dried egg, egg white, egg yolk, custard),
Desserts (e.g. gelatins and puddings)
Products made of soya protein or other soya bean fractions (e.g. soya milk and products made therefrom, soya lecithin-containing preparations, fermented products such as tofu or tempeh or products manufactured therefrom, soya sauces),
Vegetable preparations (e.g. ketchup, sauces, processed and reconstituted vegetables, dried vegetables, deep frozen vegetables, pre-cooked vegetables, vegetables pickled in vinegar, vegetable concentrates or pastes, cooked vegetables, potato preparations),
Vegetarian meat replacer, vegetarian burger
Spices or spice preparations (e.g. mustard preparations, horseradish preparations), spice mixtures and, in particular seasonings which are used, for example, in the field of snacks.
Snack articles (e.g. baked or fried potato crisps or potato dough products, bread dough products, extrudates based on maize, rice or ground nuts),
Meat products (e.g. processed meat, poultry, beef, pork, ham, fresh sausage or raw meat preparations, spiced or marinated fresh meat or cured meat products, reformed meat),
Ready dishes (e.g. instant noodles, rice, pasta, pizza, tortillas, wraps) and soups and broths (e.g. stock, savory cube, dried soups, instant soups, pre-cooked soups, retorted soups), sauces (instant sauces, dried sauces, ready-made sauces, gravies, sweet sauces).

Preferably, the particles according to the invention shall be used in products selected from the group consisting of baked goods, instant beverages, cereal products, milk products, dairy-based products, products based on fat and oil or emulsions thereof, desserts, vegetable preparations, vegetarian meat replacer, spices and seasonings, snacks, meat products, ready dishes, soups and broths and sauces.

According to a particular embodiment, the flavored product is chosen group consisting of a meat- and/or fish-based food or analogue, a stock, a savory cube, a powder mix, a beef or pork based product, a seafood, surimi, instant noodles, rice, soups, sauces, ready-made meal, frozen or chilled pizza, pasta, potato flakes or fried, noodles, a potato/tortilla chip, a microwave popcorn, nuts, a bretzel, a rice cake, a rice cracker, fermented dairy analogue beverage, acidified dairy analogue beverage, non-fermented dairy analogue beverage, cheese or cheese analogue, yoghurt or yoghurt analogue, nutritional supplement, nutritional bar, cereal, ice cream, dairy-free ice cream, confectionary product, chewing gum, hard-boiled candy and powdered drinks.

According to one embodiment, the food, pet-food or feed product comprises between and 10% by weight, preferably between 0.1 and 5% by weight of the particles of the invention.

Typically the food, pet-food or feed product further comprises proteins notably vegetable proteins or animal proteins, and mixtures thereof.

Advantageously the vegetable proteins are preferably selected among soy protein, corn, peas, canola, sunflowers, sorghum, rice, amaranth, potato, tapioca, arrowroot, chickpeas, lupins, canola, wheat, oats, rye, barley, and mixtures thereof.

The particles of the invention are particularly suitable for extruded and/or baked food, pet-food or feed products more particularly comprising animal and/or vegetable proteins. Typically, said extruded and/or baked food, pet-food or feed products may be selected among meat- and/or fish-based food or analogue and mixtures thereof (in other words, meat-based food and/or fish-based food or meat analogue or fish analogue and mixtures thereof); extruded and/or baked meat analogue or extruded and/or baked fish analogue are preferred. Non-limiting examples of extruded and/or baked food, pet-food or feed products are snack products or extruded vegetable proteins with the aim to texture the protein from which meat analogous (e.g. burgers) are prepared from. The powder composition can be added pre-extrusion or after extrusion to either, the non-extruded vegetable protein isolate/concentrate or to the textured vegetable protein from which a burger or nugget (etc.) is formed.

### Perfumed Consumer Products

The particles of the invention can be used in combination with active ingredients. An object of the invention is therefore a composition comprising:
(i) particles as defined above;
(ii) an active ingredient, preferably chosen in the group consisting of a cosmetic ingredient, skin caring ingredient, perfume ingredient, flavor ingredient, malodour counteracting ingredient, bactericide ingredient, fungicide ingredient, pharmaceutical or agrochemical ingredient, a sanitizing ingredient, an insect repellent or attractant, and mixtures thereof.

The particles of the invention can also be added in different perfumed consumer products.

Particles can be used in powder form applicable to powder consumer products.

In the case of particles including a perfume oil-based core, the products of the invention, can in particular be of used in perfumed consumer products such as product belonging to fine fragrance or “functional” perfumery. Functional perfumery includes in particular personal-care products including hair-care, body cleansing, skin care, hygiene-care as well as home-care products including laundry care and air care. Consequently, another object of the present invention consists of a perfumed consumer product comprising as a perfuming ingredient, the particles defined above.

Also, a powder consumer product comprising
from 2 to 65% by weight, relative to the total weight of the consumer product, of at least one surfactant; and
particles as defined above, wherein the active ingredient comprises a perfume as defined above is part of the invention.

Also, a liquid consumer product comprising
from 2 to 65% by weight, relative to the total weight of the consumer product, of at least one surfactant; and
particles as defined above, wherein the active ingredient comprises a perfume as defined above is part of the invention.

For the sake of clarity, it has to be mentioned that, by “perfumed consumer product” it is meant a consumer product which is expected to deliver among different benefits a perfuming effect to the surface to which it is applied (e.g. skin, hair, textile, paper, or home surface) or in the air (air-freshener, deodorizer etc). In other words, a perfumed consumer product according to the invention is a manufactured product which comprises a functional formulation also referred to as “base”, together with benefit agents, among which an effective amount of particles according to the invention.

Another object of the invention is a consumer product comprising:
a personal care active base, and
particles as defined above or the perfuming composition as defined above,
wherein the consumer product is in the form of a personal care composition.

Personal care active base in which the particles of the invention can be incorporated can be found in the abundant literature relative to such products. These formulations do not warrant a detailed description here which would in any case not be exhaustive. The person skilled in the art of formulating such consumer products is perfectly able to select the suitable components on the basis of his general knowledge and of the available literature.

The personal care composition is preferably chosen in the group consisting of a hair-care product (e.g. a dry shampoo, a hair spray), a cosmetic preparation (e.g. a vanishing cream, body lotion or a deodorant or antiperspirant), a skin-care product (e.g. a perfumed soap, bath salts, or a hygiene product), oral care product (toothpaste or mouthwash composition).

Another object of the invention is a consumer product comprising:
a home care or a fabric care active base, and
particles as defined above or the perfuming composition as defined above,
wherein the consumer product is in the form of a home care or a fabric care composition.

Home care or fabric care bases in which the particles of the invention can be incorporated can be found in the abundant literature relative to such products. These formulations do not warrant a detailed description here which would in any case not be exhaustive. The person skilled in the art of formulating such consumer products is perfectly able to select the suitable components on the basis of his general knowledge and of the available literature.

The home or fabric care composition is preferably chosen in the group consisting of powder detergent and solid scent booster.

### EXAMPLES

### Example 1

### Preparation of Extruded Particles (Particles A) According to the Process of the Invention

All the ingredients of the following table were weighted and blended in a mixing bowl starting with the solid ones and adding finally the water. The mixture was then extruded using a 16 mm lab extruder from Thermo Electron (Germany). The extrusion parameters were the following: Feeder throughput 400 g/h, die temperature 110° C., 4 barrel sections with temperatures ranged from 20° C. to 110° C. The single hole of the die has an inner diameter of 1 mm. Screw speed was set at 300 rpm.

| Amount (g) | Material |
|---|---|
| 20 | CARNAUBA WAX ¹⁾ |
| 35 | WATER |
| 2.5 | LECITHIN ²⁾ |
| 420 | MALTODEXTRIN 6 DE ³⁾ |
| 2.5 | NEOBEE ⁴⁾ |
| 40 | COFFEE FLAVOR |

¹⁾ Origin: Kahlwax
²⁾ Origin: Lasenor
³⁾ Origin: Roquette
⁴⁾ Origin: Stepan

After establishing steady state extrusion conditions (melt temperature of the extrudate of 93° C.), extrudate was chopped into discrete particles of about 1.5 mm using a rotary knife and collected through a cyclone.

### Comparative Example 2

### Preparation of Comparative Extruded Particles (Particles X)

All the ingredients of the following table were weighted and blended in a mixing bowl starting with the solid ones and adding finally the water. The mixture was then extruded using a 16 mm lab extruder from Thermo Electron (Germany). The extrusion parameters were the following: Feeder throughput 400 g/h, die temperature 110° C., 4 barrel sections with temperatures ranged from 20° C. to 110° C. The single hole of the die has an inner diameter of 1 mm. Screw speed was set at 300 rpm.

| Amount (g) | Material |
|---|---|
| 35 | WATER |
| 2.5 | LECITHIN ¹⁾ |
| 420 | MALTODEXTRIN 6 DE ²⁾ |
| 2.5 | NEOBEE ³⁾ |
| 40 | COFFEE FLAVOR |

¹⁾ Origin: Lasenor
²⁾ Origin: Roquette
³⁾ Origin: Stepan

After establishing steady state extrusion conditions (melt temperature of the extrudate of 93° C.), extrudate was chopped into discrete particles of about 1.5 mm using a rotary knife and collected through a cyclone.

### Example 3

### Water Solubility Assessment (Particles a Versus Comparative Particles X)

The difference in water solubility was assessed by microscopy by placing size by side Particles A according to the invention (example 1) and Particles X (comparative example 2). Deonized water was added between the glass plates to follow their dissolution magnified 4 times. It has been observed that Particles X are quicker soluble in water compared to Particles A of the invention, showing that the hydrophobic coating present at the surface of the particles of the present invention protects particles under humid conditions.

### Example 4

### Preparation of Extruded Particles (Particles C-I) According to the Process of the Invention

Firstly, the solid fat and the flavor were mixed together and heated at 80° C. to obtain a homogeneous liquid. After cooling, the solid fat phase was mixed with the remaining ingredients in a mixing bowl starting with the solid ones and adding finally the water. The mixture was then extruded using a 16 mm lab extruder from Thermo Electron (Germany). The extrusion parameters were the following: Feeder throughput 500 g/h, die temperature 110° C., 4 barrel sections with temperatures ranged from 20° C. to 110° C. The single hole of the die has an inner diameter of 1 mm. Screw speed was set at 300 rpm.

| | Sample | Sample | Sample | Sample | Sample | Sample | Sample |
|---|---|---|---|---|---|---|---|
| Ingredient | C | D | E | F | G | H | I |
| Maltodextrin 18 DE¹⁾ | 71 | 66.2 | 75 | 79.5 | 67.5 | 84 | 71 |
| Modified starch²⁾ | 7 | 7 | 8 | 0 | 7 | 0 | 8 |
| (OSS) | | | | | | | |
| Lecithin ³⁾ | 1 | 1 | 1 | 0 | 0 | 0 | 0 |
| Lemon flavour | 6 | 6 | 6 | 6 | 6 | 6 | 6 |
| Carnauba wax ⁴⁾ | 10 | 15 | 0 | 0 | 0 | 0 | 0 |
| Beeswax ⁴⁾ | 0 | 0 | 5 | 10 | 15 | 0 | 0 |
| Hydrogenated | 0 | 0 | 0 | 0 | 0 | 5 | 10 |
| soybean glycerides ⁵⁾ | | | | | | | |
| Water | 5 | 4.8 | 5 | 4.5 | 4.5 | 5 | 5 |
| | 100 | 100 | 100 | 100 | 100 | 100 | 100 |
| Moisture sensitivity | - - | - - - | - | - - | - - - | - | - - - |

¹⁾Origin: Roquette
²⁾Capsul ®, Origin: Ingredion
³⁾ Origin: Lasenor
⁴⁾ Origin: Kahlwax
⁵⁾ Naturewax ® S-113, Origin: Cargill

For samples C to I, after establishing steady state extrusion conditions (melt temperature of the extrudate of 99° C.), extrudate was chopped into discrete particles of about 1.5 mm using a rotary knife and collected through a cyclone. All of the samples show a good stability under moisty conditions.

1. A process for preparing an extruded particle, the process comprising the following steps:
a) mixing at least a carrier material and a plasticizer to form a mixture;
b) heating the mixture at a temperature sufficient to form a molten mass;
c) extruding the molten mass through a die to form an extrudate;
d) cutting the extrudate to form an extruded particle,
wherein a solid fat having a melting point Tm and an active ingredient, preferably comprising a flavor or a perfume, are added to the mixture in step a) and/or in the molten mass in step b), and
wherein at least step c) and step d) are carried out at a temperature greater than Tm.

2. The process according to claim 1, wherein the amount of the solid fat is comprised between 0.5 and 30% by weight based on the carrier system composed of the carrier material and the solid fat.

3. The process according to claim 1, wherein the carrier material is selected from the group consisting of starch derivatives, gums, fibers, polysaccharides, proteins, soluble flours and mixtures thereof.

4. The process according to claim 3, wherein the carrier material is selected from the group consisting of maltodextrin, dextrin, resistant starch, hydroxypropylated starch, phosphate starch phosphate, octenylsuccinated starch, starch aluminium octenyl succinate, acetylated distarch phosphate, acetylated distarch adipate, acetylated distarch adipate, hydroxypropyl distarch phosphate, acetylated oxidized starch, gum arabic, gum tragacanth, gum karaya, gum ghatti, ocra gum, glucomannan, gellan gum, alginate, inulin, fructooligosaccharides, beta glucan, arabinogalactan, glucomannan, psyllium, soluble corn fiber, tamarind seed polysaccharide, soy polysaccharide, galactomannan, xyloglucan, carrageenan, pectin, curdlan, arabinan, arabinoglactan, pea protein, soy protein, lentil proteins, chickpea protein, rice protein, potato protein, fava bean protein, mung bean protein, canola protein, soluble rice flour, soluble brown rice flour, koji rice and mixtures thereof.

5. The process according to claim 1, wherein the solid fat is selected from the group consisting of beeswax, candelilla wax, carnauba wax, paraffin wax, palm fat, shea butter, algae butter, hydrogenated vegetable oil, palm stearin, shea stearin, rice stearin, sunflower stearin, tallow, cocoa butter, saturated fatty acid and mixtures thereof.

6. The process according to claim 1, wherein a lubricant is added in step a).

7. The process according to claim 1, wherein a carbohydrate selected from the group consisting of sucrose, glucose, lactose, maltose, fructose, ribose, dextrose, isomalt, sorbitol, glucose syrup, mannitol, xylitol, lactitol, maltitol, pentatol, arabinose, pentose, xylose, galactose, trehalose, and mixtures thereof is added in step a).

8. An extruded particle obtainable by the process according to claim 1.

9. The extruded particle according to claim 8, wherein it comprises:
an active ingredient, and
a coating comprising a solid fat.

10. The extruded particle according to claim 8, wherein the particle size is greater than 300 microns.

11. The extruded particle according to claim 8, wherein it comprises between 1 and 20% by weight of flavor based on the total weight of the particle.

12. A food or beverage consumer product comprising the particles as defined in claim 8, wherein it is chosen in the group consisting of beverage, a sweet good, and a savory good.

13. The process according to claim 1, wherein the plasticizer is water.

14. The process according to claim 1, wherein the amount of the solid fat is comprised between 1 and 10% by weight based on the carrier system composed of the carrier material and the solid fat.

15. The process according to claim 1, wherein
the carrier material is selected from the group consisting of starch derivatives, gums, fibers, polysaccharides, proteins, soluble flours and mixtures thereof; and
the solid fat is selected from the group consisting of beeswax, candelilla wax, carnauba wax, paraffin wax, palm fat, shea butter, algae butter, hydrogenated vegetable oil, palm stearin, shea stearin, rice stearin, sunflower stearin, tallow, cocoa butter, saturated fatty acid and mixtures thereof.

16. The process according to claim 15, wherein the carrier material is selected from the group consisting of maltodextrin, dextrin, resistant starch, hydroxypropylated starch, phosphate starch phosphate, octenylsuccinated starch, starch aluminium octenyl succinate, acetylated distarch phosphate, acetylated distarch adipate, acetylated distarch adipate, hydroxypropyl distarch phosphate, acetylated oxidized starch, gum arabic, gum tragacanth, gum karaya, gum ghatti, ocra gum, glucomannan, gellan gum, alginate, inulin, fructooligosaccharides, beta glucan, arabinogalactan, glucomannan, psyllium, soluble corn fiber, tamarind seed polysaccharide, soy polysaccharide, galactomannan, xyloglucan, carrageenan, pectin, curdlan, arabinan, arabinoglactan, pea protein, soy protein, lentil proteins, chickpea protein, rice protein, potato protein, fava bean protein, mung bean protein, canola protein, soluble rice flour, soluble brown rice flour, koji rice and mixtures thereof.

17. The process according to claim 15, wherein a lubricant, a carbohydrate or a mixture thereof are added in step a), wherein the carbohydrate is selected from the group consisting of sucrose, glucose, lactose, maltose, fructose, ribose, dextrose, isomalt, sorbitol, glucose syrup, mannitol, xylitol, lactitol, maltitol, pentatol, arabinose, pentose, xylose, galactose, trehalose, and mixtures thereof.

18. The process according to claim 2, wherein
the carrier material is selected from the group consisting of starch derivatives, gums, fibers, polysaccharides, proteins, soluble flours and mixtures thereof; and
the solid fat is selected from the group consisting of beeswax, candelilla wax, carnauba wax, paraffin wax, palm fat, shea butter, algae butter, hydrogenated vegetable oil, palm stearin, shea stearin, rice stearin, sunflower stearin, tallow, cocoa butter, saturated fatty acid and mixtures thereof.

19. The process according to claim 18, wherein the carrier material is selected from the group consisting of maltodextrin, dextrin, resistant starch, hydroxypropylated starch, phosphate starch phosphate, octenylsuccinated starch, starch aluminium octenyl succinate, acetylated distarch phosphate, acetylated distarch adipate, acetylated distarch adipate, hydroxypropyl distarch phosphate, acetylated oxidized starch, gum arabic, gum tragacanth, gum karaya, gum ghatti, ocra gum, glucomannan, gellan gum, alginate, inulin, fructooligosaccharides, beta glucan, arabinogalactan, glucomannan, psyllium, soluble corn fiber, tamarind seed polysaccharide, soy polysaccharide, galactomannan, xyloglucan, carrageenan, pectin, curdlan, arabinan, arabinoglactan, pea protein, soy protein, lentil proteins, chickpea protein, rice protein, potato protein, fava bean protein, mung bean protein, canola protein, soluble rice flour, soluble brown rice flour, koji rice and mixtures thereof.

20. The process according to claim 18, wherein a lubricant, a carbohydrate or a mixture thereof are added in step a), wherein the carbohydrate is selected from the group consisting of sucrose, glucose, lactose, maltose, fructose, ribose, dextrose, isomalt, sorbitol, glucose syrup, mannitol, xylitol, lactitol, maltitol, pentatol, arabinose, pentose, xylose, galactose, trehalose, and mixtures thereof.
